(19) United States
(12) Patent Application Publication
(10) Pub. No.: US 2009/0178540 A1
(43) Pub. Date: Jul. 16, 2009

(54) CLOSED HI-HAT CYMBALS MOUNTABLE ON STANDARD CYMBAL STANDS OR ARMS

(76) Inventor: John Stannard, Clearwater (FL)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/348,327

(22) Filed: Jan. 5, 2009

Related U.S. Application Data
(60) Provisional application No. 61/020,785, filed on Jan. 14, 2008.

(51) Int. Cl. G10D 13/02

(52) U.S. Cl. 84/422.3

(57) ABSTRACT

A pair of hi-hat cymbals each featuring respective inverted center cups which place the respective center holes in close enough proximity to allow mounting in a closed position on a standard cymbal stand and the cymbals can be adjusted in tightness by a standard cymbal wing nut. In another embodiment, the invention is a pair of hi-hat cymbals featuring respective inverted center cups which place the center holes in close enough proximity to allow mounting on a standard cymbal stand, and the cymbals can be adjusted in tightness by a standard cymbal wing nut. This latter cymbal assembly can be divided by one or more standard cymbal felts or other dividers on a standard cymbal stand or arm to create a pair of independently ringing cymbals with a resonant air cavity.

### RELATED APPLICATION

This application claims the benefit of U.S. Provisional Patent Application Ser. No. 61/020,785 filed Jan. 14, 2008.

### FIELD OF THE INVENTION

This invention relates to hi-hat cymbals which mount on standard cymbal stands or cymbal arms.

### BACKGROUND OF THE INVENTION

Prior art hi-hat cymbal assemblies consisted of a pair of cymbals which are mounted on a special cymbal stand with a foot control pedal which can raise and lower the top cymbal from an open to a closed position, allowing a variety of musical percussive sounds.

Drummers often mount additional supplemental hi-hat pairs in a permanently closed position. Closed hi-hat cymbal pairs are often used to supplement the main hi-hat assembly which opens and closes by foot control. These supplemental prior art hi hats have been mounted to hi-hat stands.

The prior art design poses two problems. It limits the height and angle of mounting. It also creates a cost issue since hi-hat stands cost more than cymbal stands and substantially more than cymbal arm clamps. It also creates a space constraint since hi-hat stands take up substantial floor space compared to cymbal arms. With traditional hi-hat cymbals, the combined height of the top and bottom cups create a gap which prevent them from simply being mounted on a cymbal stand or arm. Even in prior designs where the bottom of the pair of cymbals was a low-profile plain dome shape, the gap was still too great to allow mounting on a standard cymbal stand or arm.

### SUMMARY OF THE INVENTION

What is needed then is a hi-hat cymbal pair which can be mounted on standard cymbal stands and cymbal arm clamps with no additional hardware needed.

This invention creates the needed smaller gap by inverting the cups of both top and bottom cymbals and assembling them together as a pair. For purposes of this invention, the definition of an inverted cup shall be a depression or concave area formed in or around the center area of the cymbal, said concave opposing the general convex curve of the main body of the cymbal.

These inverted cups allow the center holes in the pair of cymbals to be close enough to allow the pair to be attached by standard felt washers and wing nuts to a cymbal stand or arm. A gap of 0.250 inches was found to work well, but a greater or lesser gap could be utilized depending on the desired shape or profile of the cymbals-limited by the length of the mounting screw on standard cymbal arms and stands. The depth of the cups can not be so deep so as to prevent the outer edges of the two cymbals from touching when mounted on the cymbal stand or arm.

An important feature of this invention is the ability to “tighten” the sound with the wing nut of the stand or arm. By tightening said wing nut, the natural rattling hi-hat style sound of the pair of cymbals will become more brief and controlled. By loosening the nut, the two cymbals will be more free to bounce against each other and vibrate and rattle together longer. This simple adjusting process is very easy and rapid, a feature so rapid that it can be done during live or recorded performance in the middle of a piece of music.

Another feature of this invention is the ability to separate the two cymbals by using a standard cymbal felt washer or other material as a divider, then mounting the pair together on a single cymbal stand or arm. This creates a double cymbal-bell with a resonant air cavity. The air cavity can alter the sound and increase certain low frequency tones in certain embodiments of the invention.

### BRIEF DESCRIPTION OF THE DRAWINGS

In the accompanying drawings,

FIG. 1 depicts a cross-sectional view of the relative positions of a prior art conventional hi-hat cymbal pair in the nearly closed position with a relatively large gap between the domes;

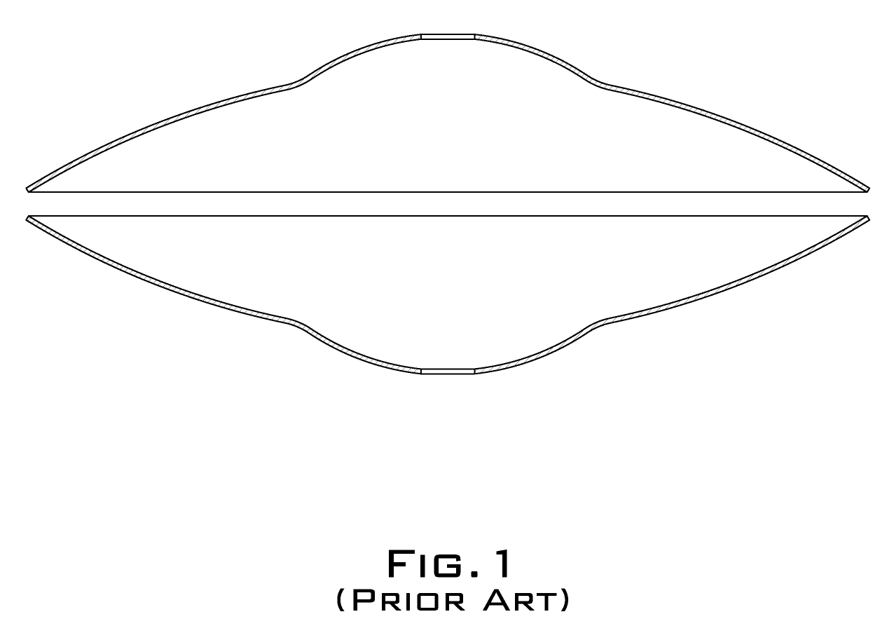

FIG. 2 depicts a cross-sectional view of the relative positions of a prior art conventional hi-hat cymbal pair in the nearly closed position with the bottom cymbal having a low profile simple dome shape and a gap similar to that of FIG. 1;

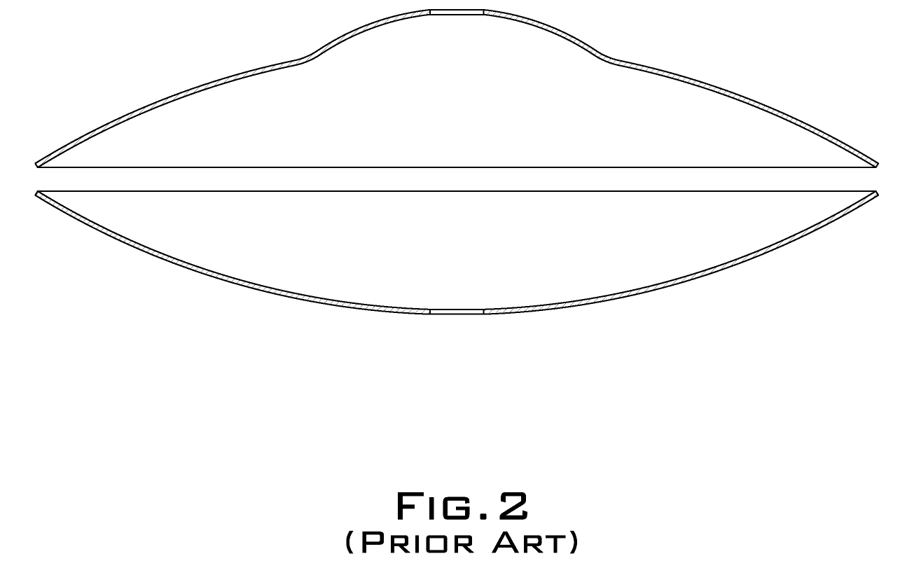

FIG. 3 depicts a cross-sectional view of the present invention mounted on a standard cymbal stand or arm showing the small gap between the center hole areas in the cymbals; and

FIG. 4 depicts a cross-sectional view of another embodiment of the present invention mounted on a standard cymbal stand or arm showing the two cymbals separated by a standard felt washer, which increases the gap between the cymbals enough to allow independent ringing and the creation of a resonant air cavity.

### DETAILED DESCRIPTION OF THE INVENTION

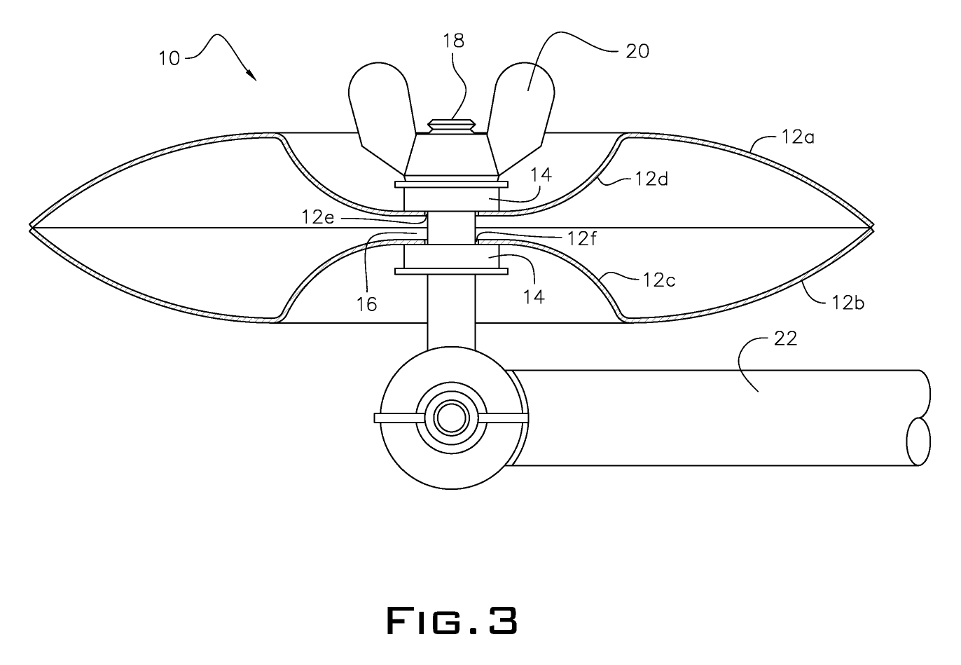

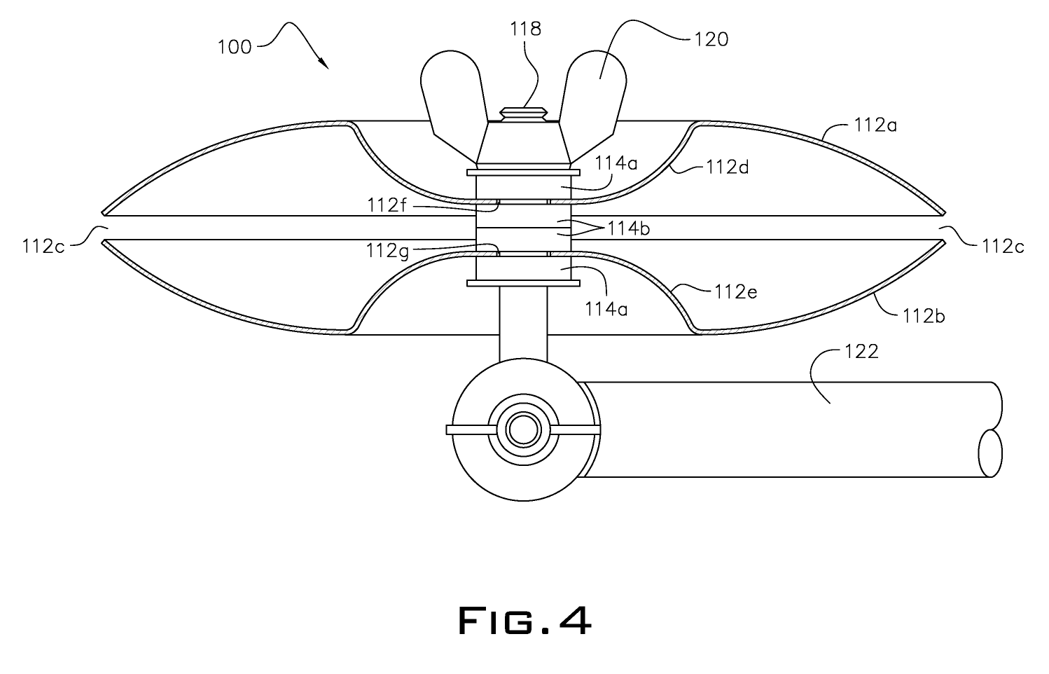

The present invention is a pair of hi-hat cymbals depicted in FIG. 3 and enumerated as 10 generally and further depicted as another embodiment in FIG. 4 where the depicted embodiment is enumerated as 100 generally.

FIG. 3 depicts a pair of hi-hat cymbals (top cymbal 12a and bottom cymbal 12b) each featuring respective inverted center cups 12c, 12d which place the respective center holes 12e, 12f in close enough proximity to allow mounting in a closed position on a standard cymbal stand or cymbal extension arm clamp 22, wherein the pair of cymbals 12a, 12b can be adjusted in tightness by a standard cymbal wing nut 20 screwed on the cymbal stand screw threads 18. Standard cymbal stand felt washers 14 are located as shown in FIG. 3 as well.

In another embodiment, as shown in FIG. 4, the invention 100 is a pair of hi-hat cymbals (top cymbal 112a and bottom cymbal 112b) featuring respective inverted center cups 112d, 112e which place the center holes 112f, 112g in close enough proximity to allow mounting on a standard cymbal stand or cymbal extension arm clamp 122, wherein the pair of cymbals 112a, 112b can be adjusted in tightness by a standard cymbal wing nut 120 and wherein the cymbal assembly can be divided by one or more dividers 114b such as standard cymbal felts or other suitable material that provides similar characteristics as felt washers, on a standard cymbal stand or arm 122 to create a pair of independently ringing cymbals with a resonant air cavity. See the outside gap 112c formed by the divider(s) 114b. As with the embodiment of FIG. 3, standard cymbal stand felt washers 114a are located as shown in FIG. 4 as well.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A pair of hi-hat cymbals comprising:
a top cymbal and a bottom cymbal, each featuring respective inverted center cups which place respective center holes for each of said top and lower cymbals in close enough proximity to allow mounting in a closed position on a standard cymbal stand or cymbal extension arm clamp,
wherein said cymbals are adjustable in tightness by a cymbal wing nut.

2. A pair of hi-hat cymbals comprising:
a top cymbal and a bottom cymbal, each featuring respective inverted center cups which place respective center holes of each of said top and lower cymbals in close enough proximity to allow mounting on a cymbal stand or cymbal extension arm clamp,
wherein said cymbals are adjustable in tightness by a cymbal wing nut, and
wherein the top and bottom cymbals are divided by one or more dividers on said cymbal stand or cymbal extension arm clamp to create a pair of independently ringing cymbals with a resonant air cavity.
